(19) United States
(12) Patent Application Publication
(10) Pub. No.: US 2023/0335758 A1
(43) Pub. Date: Oct. 19, 2023

(54) REDOX FLOW BATTERY

(71) Applicant: University of Massachusetts, Boston, MA (US)

(72) Inventors: Patrick J. Cappillino, Raynham, MA (US); Ertan Agar, Lowell, MA (US)

(21) Appl. No.: 18/299,947

(22) Filed: Apr. 13, 2023

Related U.S. Application Data
(60) Provisional application No. 63/362,936, filed on Apr. 13, 2022.

(51) Int. Cl. H01M 4/90; H01M 8/18

(52) U.S. Cl. CPC H01M 4/9008; H01M 8/188

(57) ABSTRACT

Various aspects disclosed relate to a redox flow battery that includes an anode in communication with a current collector and comprising a first solid charge storage medium disposed within the anode. The redox flow battery further includes a cathode in communication with the current collector and comprising a second solid charge storage medium disposed within the cathode. At least one of the anode, current collector, or cathode includes a complex having a structure according to Formula I:

[ML₂]ₘ⁻²[CAT]ₙ⁺² (I),
wherein,
   M is metal;
   L is a ligand.

### PRIORITY APPLICATION

This application claims priority to U.S. Provisional Patent Application Ser. No. 63/362,936, filed on Apr. 13, 2022, the disclosure of which is incorporated by reference herein in its entirety.

### BACKGROUND

Redox flow batteries (RFBs) are a promising large-scale energy storage technology for integration of intermittent renewable sources, such as wind and solar, into the electrical grid. As fossil fuel consumption diminishes over the next several years, increasing reliance on these green energy sources can lead to expanding market potential.

### SUMMARY OF THE INVENTION

Various aspects disclosed relate to a redox flow battery that includes an anode in communication with a current collector and comprising a first solid charge storage medium disposed within the anode. The redox flow battery further includes a cathode in communication with the current collector and comprising a second solid charge storage medium disposed within the cathode. At least one of the anode, current collector, or cathode includes a complex dispersed therein, the complex having a structure according to Formula I:

[ML₂]ₘ⁻²[CAT]ₙ⁺² (I),
wherein,
   M is metal;
   L is a ligand has a structure according to Formula II:

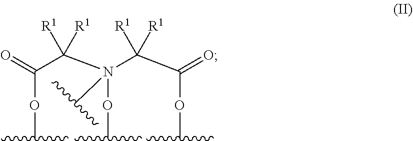

at each occurrence R₁ is independently chosen from —H, substituted or unsubstituted (C₁-C₁₀)hydrocarbyl, —F, —Cl, —Br, and —I; n and m are independently 1 to 10; CAT is a cation having the metal in a first oxidation state when the complex is dispersed in the anode and the metal is in a second oxidation state when the complex is dispersed in the cathode.

Among several types of redox flow batteries (RFBs) under development, non-aqueous redox flow batteries (NRFBs) have the potential to approach the energy density of lithium-ion batteries, while maintaining the advantages of flow systems, including ability to decouple power and energy ratings, and thermal stability. Despite their promise, NRFBs suffer from low energy densities because the solubility limitation of redox species in non-aqueous solvents remains relatively lower compared to water. One approach for improving the energy density of NRFBs is the utilization of solid charge storage materials, which are reversibly oxidized or reduced in the electrolyte tanks upon interaction with the redox active species (mediators) dissolved in electrolyte (e.g., redox targeting flow battery (RTFB)). Various aspects according to the instant disclosure provides a RTFB using a highly stable, bio-inspired mediator, vanadium(IV/V)bis-hydroxyiminodiacetate (VBH), coupled with cobalt hexacyanoferrate (CoHCF) as the solid charge storage material. Based on the charge/discharge cycling experiments, the energy capacity was found to enhance by ˜5× when CoHCF pellets were added into the tank compared to the case without CoHCF. With the pellet approach, up to the ˜70% of the theoretical capacity of CoHCF were utilized at 10 mA·cm⁻² current density. Sufficient evidence has indicated that this concept utilizing redox targeting reactions makes it possible to surpass the solubility limitations of the active material, allowing for unprecedented improvements to the energy density of RFBs.

### BRIEF DESCRIPTION OF THE FIGURES

The drawings illustrate generally, by way of example, but not by way of limitation, various embodiments of the present invention.

FIG. 1 is a schematic representation of a redox flow battery including the complex.

FIG. 2 shows various examples of a redox flow battery including properties thereof.

FIG. 3A is a schematic of the symmetric flow cell cycling setup—CoHCF powder were added to the (+) tank (capacity limited side), according to the instant Example.

FIG. 3B is a graph showing the cell potential of the flow cell of FIG. 3A.

FIG. 3C is a graph showing the capacity reached for the flow cell of FIG. 3A.

FIG. 4A is a schematic of the symmetric flow cell cycling setup—CoHCF powder were added to the (+) tank (capacity limited side), according to the instant Example.

FIG. 4B is a graph showing the cell potential of the flow cell of FIG. 4A.

FIG. 4C is a graph showing the capacity reached for the flow cell of FIG. 4A.

FIG. 5A are CVs of CoHCF coated graphite sheet in 50 mM TBAPF6 in MeCN compared with the CVs of graphitic carbon rod in 50 mM (TBA)₂VBH in MeCN.

FIG. 5B is a UV-vis spectra of (TBA)₂VBH solution before and after addition of CoHCF and with various concentration of KPF₆ salt.

FIG. 6 shows infrared (IR) spectra of contaminated CoHCF, pure CoHCF, the subtraction of contaminated CoHCF—pure CoHCF, and KNO3.

FIGS. 7A-7G are plots showing galvanostatic cycling of various materials.

FIGS. 8A-8B show capacity of various materials.

FIGS. 9A-9D show galvanostatic charge and discharge cycling of various materials.

### DETAILED DESCRIPTION OF THE INVENTION

Reference will now be made in detail to certain embodiments of the disclosed subject matter, examples of which are illustrated in part in the accompanying drawings. While the disclosed subject matter will be described in conjunction with the enumerated claims, it will be understood that the exemplified subject matter is not intended to limit the claims to the disclosed subject matter.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts can be carried out in any order without departing from the principles of the disclosure, except when a temporal or operational sequence is explicitly recited. Furthermore, specified acts can be carried out concurrently unless explicit claim language recites that they be carried out separately. For example, a claimed act of doing X and a claimed act of doing Y can be conducted simultaneously within a single operation, and the resulting process will fall within the literal scope of the claimed process.

The term “about” as used herein can allow for a degree of variability in a value or range, for example, within 10%, within 5%, or within 1% of a stated value or of a stated limit of a range, and includes the exact stated value or range.

The term “substantially” as used herein refers to a majority of, or mostly, as in at least about 50%, 60%, 70%, 80%, 90%, 95%, 96%, 97%, 98%, 99%, 99.5%, 99.9%, 99.99%, or at least about 99.999% or more, or 100%.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that can be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that can be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R can be hydrogen or a carbon-based moiety; for example, R can be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms can together with the nitrogen atom or atoms form a heterocyclyl.

The term “hydrocarbon” or “hydrocarbyl” as used herein refers to a molecule or functional group that includes carbon and hydrogen atoms. The term can also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and can be alkyl, alkenyl, alkynyl, aryl, cycloalkyl, acyl, or any combination thereof. Hydrocarbyl groups can be shown as (Cₐ-C_{b})hydrocarbyl, wherein a and b are integers and mean having any of a to b number of carbon atoms. For example, (C₁-C₄)hydrocarbyl means the hydrocarbyl group can be methyl (C₁), ethyl (C₂), propyl (C₃), or butyl (C₄), and (C₀-C_{b})hydrocarbyl means in certain embodiments there is no hydrocarbyl group.

The term “alkyl” as used herein refers to straight chain and branched alkyl groups and cycloalkyl groups having from 1 to 40 carbon atoms, 1 to about 20 carbon atoms, 1 to 12 carbons or, in some embodiments, from 1 to 8 carbon atoms. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups. As used herein, the term “alkyl” encompasses n-alkyl, isoalkyl, and anteisoalkyl groups as well as other branched chain forms of alkyl. Representative substituted alkyl groups can be substituted one or more times with any of the groups listed herein, for example, amino, hydroxy, cyano, carboxy, nitro, thio, alkoxy, and halogen groups.

The term “acyl” as used herein refers to a group containing a carbonyl moiety wherein the group is bonded via the carbonyl carbon atom. The carbonyl carbon atom is bonded to a hydrogen forming a “formyl” group or is bonded to another carbon atom, which can be part of an alkyl, aryl, aralkyl cycloalkyl, cycloalkylalkyl, heterocyclyl, heterocyclylalkyl, heteroaryl, heteroarylalkyl group or the like. An acyl group can include 0 to about 12, 0 to about 20, or 0 to about 40 additional carbon atoms bonded to the carbonyl group. An acyl group can include double or triple bonds within the meaning herein. An acryloyl group is an example of an acyl group. An acyl group can also include heteroatoms within the meaning herein. A nicotinoyl group (pyridyl-3-carbonyl) is an example of an acyl group within the meaning herein. Other examples include acetyl, benzoyl, phenylacetyl, pyridylacetyl, cinnamoyl, and acryloyl groups and the like. When the group containing the carbon atom that is bonded to the carbonyl carbon atom contains a halogen, the group is termed a “haloacyl” group. An example is a trifluoroacetyl group.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some embodiments, the cycloalkyl group can have 3 to about 8-12 ring members, whereas in other embodiments the number of ring carbon atoms range from 3 to 4, 5, 6, or 7. Cycloalkyl groups further include polycyclic cycloalkyl groups such as, but not limited to, norbornyl, adamantyl, bornyl, camphenyl, isocamphenyl, and carenyl groups, and fused rings such as, but not limited to, decalinyl, and the like. Cycloalkyl groups also include rings that are substituted with straight or branched chain alkyl groups as defined herein. Representative substituted cycloalkyl groups can be mono-substituted or substituted more than once, such as, but not limited to, 2,2-, 2,3-, 2,4- 2,5- or 2,6-disubstituted cyclohexyl groups or mono-, di- or tri-substituted norbornyl or cycloheptyl groups, which can be substituted with, for example, amino, hydroxy, cyano, carboxy, nitro, thio, alkoxy, and halogen groups. The term “cycloalkenyl” alone or in combination denotes a cyclic alkenyl group.

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups. In some embodiments, aryl groups contain about 6 to about 14 carbons in the ring portions of the groups. Aryl groups can be unsubstituted or substituted, as defined herein. Representative substituted aryl groups can be mono-substituted or substituted more than once, such as, but not limited to, a phenyl group substituted at any one or more of 2-, 3-, 4-, 5-, or 6-positions of the phenyl ring, or a naphthyl group substituted at any one or more of 2- to 8-positions thereof.

The term “aralkyl” as used herein refers to alkyl groups as defined herein in which a hydrogen or carbon bond of an alkyl group is replaced with a bond to an aryl group as defined herein. Representative aralkyl groups include benzyl and phenylethyl groups and fused (cycloalkylaryl)alkyl groups such as 4-ethyl-indanyl. Aralkenyl groups are alkenyl groups as defined herein in which a hydrogen or carbon bond of an alkyl group is replaced with a bond to an aryl group as defined herein.

The term “heterocyclyl” as used herein refers to aromatic and non-aromatic ring compounds containing three or more ring members, of which one or more is a heteroatom such as, but not limited to, N, O, and S.

The term “heteroaryl” as used herein refers to aromatic ring compounds containing 5 or more ring members, of which, one or more is a heteroatom such as, but not limited to, N, O, and S; for instance, heteroaryl rings can have 5 to about 8-12 ring members. A heteroaryl group is a variety of a heterocyclyl group that possesses an aromatic electronic structure.

The term “heterocyclylalkyl” as used herein refers to alkyl groups as defined herein in which a hydrogen or carbon bond of an alkyl group as defined herein is replaced with a bond to a heterocyclyl group as defined herein. Representative heterocyclyl alkyl groups include, but are not limited to, furan-2-yl methyl, furan-3-yl methyl, pyridine-3-yl methyl, tetrahydrofuran-2-yl ethyl, and indol-2-yl propyl.

Redox flow batteries (RFBs) are considered a prime candidate for addressing the intermittency problem in renewable energy sources, due to their unique architecture that allows for unparalleled scalability and flexibility required for grid integration. Unlike traditional batteries, electrolytes of RFBs are stored in external tanks and circulated through an electrochemical reactor. The key advantage of these systems is that power generation and energy storage are decoupled. While the volume of electrolyte and the energy rating can be changed to obtain the required capacity, the size of the cell dictates power rating, providing flexibility and modularity.

Despite their advantages compared to conventional rechargeable batteries, the low energy density of RFBs remains a critical problem, requiring large electrolyte tanks to achieve rather modest energy storage capacities (e.g., less than 50-100 Wh·L⁻¹), which are significantly lower than the typical energy density values of Li-ion batteries. This is because the energy density is dependent on the concentration of active species dissolved in electrolytes. Significant effort has been placed toward enhancing the solubility of various active species in electrolyte solutions. Previous work has focused on improving solubility by changing the composition of the supporting electrolyte, introducing various additives and covalent and ionic modification to active species. Other efforts have attempted to expand the stable operating voltage window as a means to enhance the energy density of RFBs. Generally, this requires transitioning to non-aqueous electrolytes. The demand for higher energy density systems, pushing towards higher active material concentration, has resulted in higher viscosity in non-aqueous redox flow battery (NRFB) electrolytes which hinders practical applications due to pumping losses and decreased conductivity. Recent estimates suggest electrolyte viscosity no greater than 10-20 cP and conductivity more than 5-10 mS·cm⁻¹ are necessary for practical implementation.

Further, since viscosity generally increases with solution concentration, there may be an optimal condition for the active species, supporting salt, and solvents concentrations that is below the maximum, as increases in capacity are offset by performance losses.

Very recently, a new strategy was introduced based on building a redox-active organic molecule into an insoluble polymer to develop mediator/solid-storage-material pairs with inherently matched standard potentials.

Identification of a suitable redox mediator is a critical initial step for the rational design of RTFBs. Disclosed herein is a bio-inspired redox active material based on a molecule known as Amavadin that naturally occurs in mushrooms of the Amanita genus. Natural selection pressures on these organisms have shut down decomposition mechanisms by chelating vanadium ions extraordinarily tightly and with high specificity. This compound exhibits the highest stability constant ever measured for a vanadium(iv) ion, with a log equilibrium constant (log K_{eq}) of 23.

Disclosed herein is a RTFB using the bio-inspired electrolyte and a suitable solid storage material to provide evidence that the addition of a compatible solid material greatly improves the energy density.

A typical RTFB can typically include an anode in communication with a current collector that includes a first solid charge storage medium disposed within the anode. The RTFB further includes a cathode in communication with the current collector and includes a second solid charge storage medium disposed within the cathode.

The first solid charge storage medium (or anode solution) can include a hexacyanoferrate, a metal oxide, a pyrophosphate, an interculator, a redox-active polymer, a metal-salt precipitate system, or a mixture thereof. The second solid charge storage medium (or cathode solution) can include hexacyanoferrate complex. Although hexacyanoferrates are mentioned, it is within the scope of this disclosure to include other hexacyanometalates. Examples of hexacyanoferrate complexes include cobalt hexacyanoferrate, potassium hexacyanoferrate, or a mixture thereof. In a particular example, the hexacyanoferrate includes cobalt hexacyanoferrate. The amount of hexacyanoferrate can be dependent on the size of the cathode and anode, respectively. If the first solid charge storage medium and the second charge storage medium, both include a hexacyanoferrate, the respective cations of the hexacyanoferrate will be different.

The at least one of the anode, current collector, and cathode include a complex that can shuttle electrons. According to the disclosure a suitable complex can have a structure according to Formula I or IA:

[MLₓ]ₘ⁻²[CAT]ₙ⁺² (I),

[ML₂]⁻²[CAT]⁺² (IA),

In Formula I, M is metal and L is a ligand. The metal can be any suitable metal. For example, the metal can be a transition metal. Examples of suitable transition metals include vanadium (V), chromium (Cr), manganese (Mn), iron (Fe), cobalt (Co), nickel (Ni), copper (Cu), or zinc (Zn). The metal can have any suitable oxidation state. For example, if the metal is V, then the metal can be at least one of V(iv), V(v) or V(iii).

The cation can be any suitable cation with the appropriate stoichiometry to balance the charge on [ML_{2]}^{-x}. As shown in Formula I, the value x is the same and m and n are each independently chosen such that overall charge of the complex is 0. In some examples the cation can be a monocation, dication, or trication. The selection of a cation can be driven in part by the ability of the cation to increase the solubility of the complex. Examples of suitable cations include Ca⁺², 2Li⁺, 2NMe⁺, (NMe₄⁺/H₅O₂⁺), 2Na⁺, 2K⁺, Be⁺², and Mg⁺². In further examples, in addition to the enumerated cations, other transitional metals can be used as well as metals such as aluminum, gallium, or an organic cation (e.g., imidazolium, pyrrolidinium, or anilinium). The specific selection of the cation in the electrolyte solution of the anode (negative electrolyte solution) and the electrolyte solution of the cathode (positive electrolyte solution). Selection of the cation can be driven by a desire to match the intercalation potential of the respective first solid charge storage medium located in the anode and the second solid charge storage medium locate in the cathode. The cation can be redox active as well. In Formula I, CAT is a cation. The values m and n are independently 1 to 10. The value x can be 1 to 3

The ligand L has a structure according to Formula II:

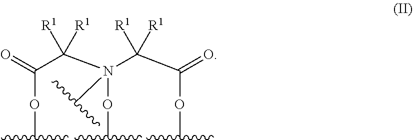

In Formula II, each of the respective wavy bonds represents a coordinate covalent bond between the metal and each oxygen as well as the nitrogen. At each occurrence in Formula II, R¹ is independently chosen from —H, substituted or unsubstituted (C₁-C₁₀)hydrocarbyl, —F, —Cl, —Br, and —I. In some examples, at each occurrence R¹ is —H. In some examples at each occurrence R¹ is (C₁-C₁₀)alkyl. In some examples at each occurrence R¹ is —F. In some examples, at least one of occurrence of R¹ is not —CH₃.

According to various aspects, the substituted or unsubstituted (C₁-C₁₀)hydrocarbyl of —R¹, can be the structure according to any one of Formulas (X)-(XXVII):

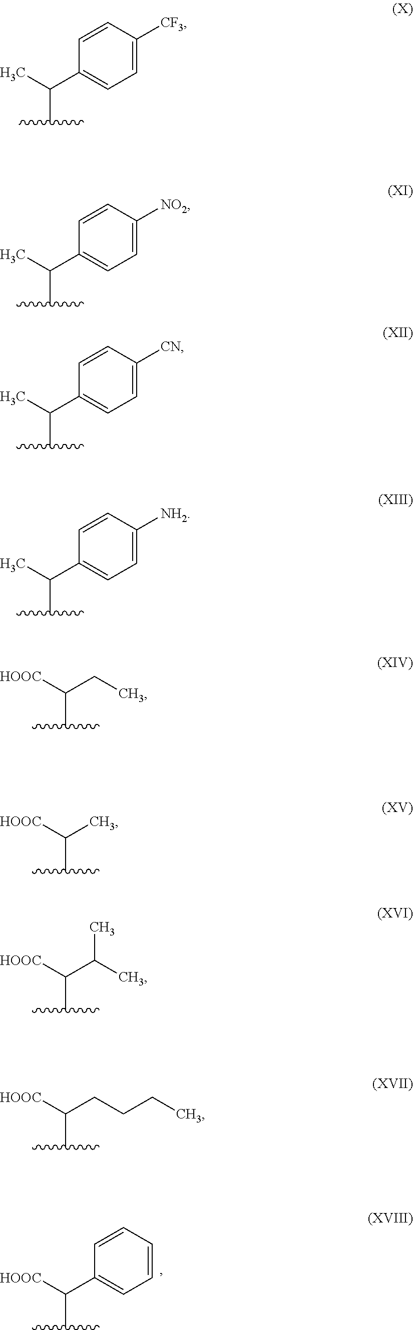

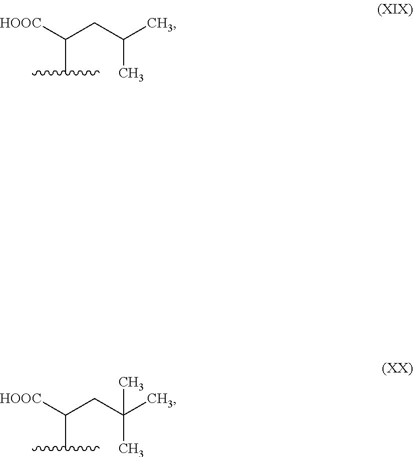

The complex is an 8-coordinate complex. An example of the complex is shown in the structure according to Formula III:

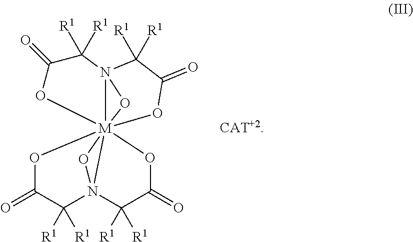

As shown in Formula III, the complex includes two ε-2-hydroxyimino-binding motifs. In such a motif, a nitrogen atom and an adjacent oxygen atom both attach to a metal atom through a coordinate covalent bond. Without intending to be bound to any theory, the inventors believe that the presence of this motif increases the stability of the complex.

Other examples of the complex include the structure according to Formula (IV):

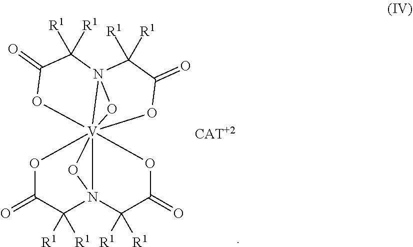

Still other examples of the complex include the structure according to Formula (V):

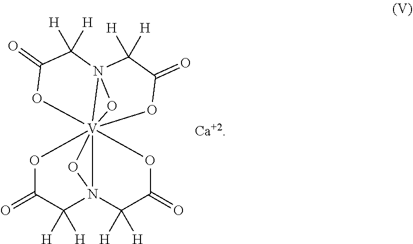

Another example of the complex includes the structure according to Formula (VI):

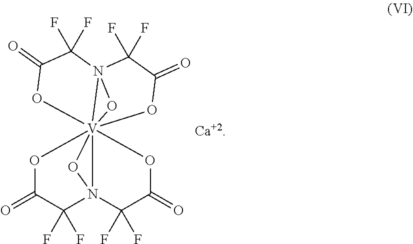

According to various embodiments a method of making the complex includes mixing the metal and a structure according to Formula (VII):

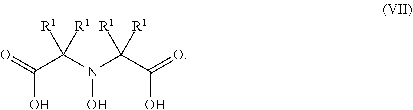

In the mixture the ratio of metal to the structure of Formula VII is about 2:1. The structure according to Formula VII can be made by mixing NH₃OH Cl with a structure according to Formula (VIII):

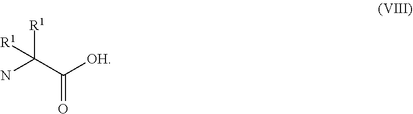

As shown with respect to the complex of Formulas (V) and (VI) the cation can be calcium. However, in certain applications it may be desirable to substitute calcium for a different cation such as the other cations described herein. To substitute calcium, the complex according to either of Formula V or VI can be mixed with a solvent and a salt including a fluoride and the desired cation. In solution the calcium precipitates out of solution as CaF₂. This leaves the desired cation in the place of the calcium of the complex of Formulas (V) and (VI). The complex can be separated from the precipitate through filtration.

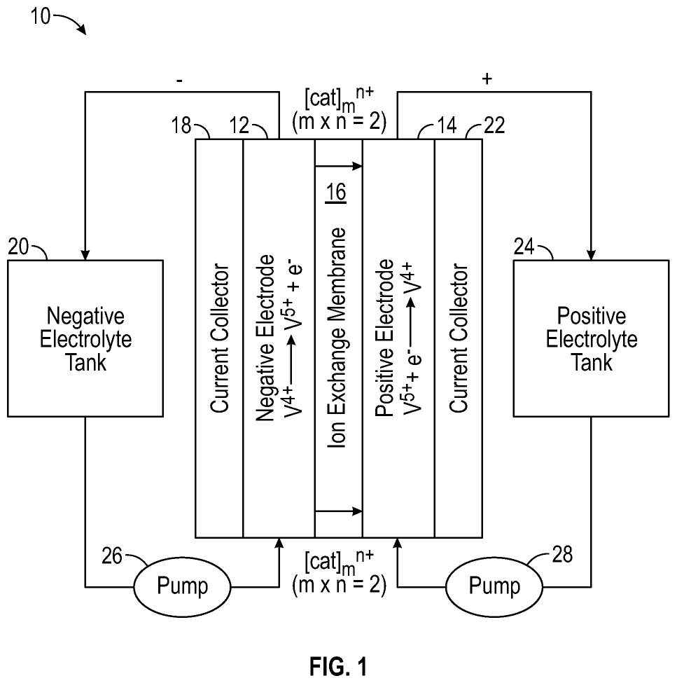

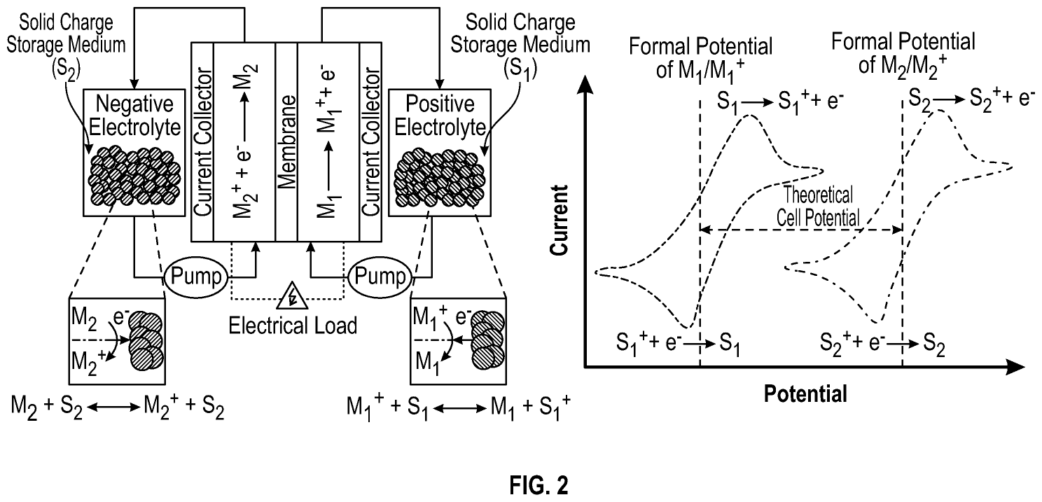

Any of the complexes described herein can be included in a battery such as a redox flow battery. FIG. 1 is a schematic representation of a redox flow battery 10 including the complex. As shown in FIG. 1, the battery includes an anode solution 12. A first quantity of the complex is disposed therein. The metal in the complex of the anode solution is in a first oxidation state. The battery also includes a cathode solution 14. The cathode solution 14 includes a second quantity of the complex. The metal in the complex of the cathode is in a second oxidation state that is different than the first oxidation state. An ion-exchange membrane 16 is disposed between the anode solution and the cathode solution. Although the complex is described as a component of the anode solution is within the scope of this disclosure for the complex to be a component of the cathode solution as well. In further embodiments, the complex may be a component of both the anode solution and the cathode solution.

In either of the anode solution or the cathode solution, the first quantity of the complex and the second quantity of the complex can be optionally dispersed within a solvent. The solvent can be an aqueous or nonaqueous solvent. In examples where the solvent is a nonaqueous solvent, the solvent can be chosen from any suitable nonaqueous solvent. Examples of suitable nonaqueous solvents include N,N-dimethylacetamide, ethylene carbonate, N-methyl-2-pyrrolidone, nitromethane, γ-valerolacetone, methoxyacetonitrile, γ-butyrolactone, acetonitrile, trimethyl phosphate, propylene carbonate, 1,2-butylene carbonate, 3-methoxypropionitrile, N,N-dimethylformamide, diglyme, 1,2-dimethoxyethane, 4-methyl-2-pentanone ethyl acetate, 2-propanol nitroethane, toluene, hexane, acetone, dichloromethane, methanol, tetrahydrofuran, ethanol, and 1-propanol and mixtures thereof.

The concentration of the complex in the anode solution is substantially equivalent to a concentration of the complex in the cathode solution. In some examples the concentration of the complex in cathode ranges from about 0.01 M to about 0.5 M, about 0.02 M to about 0.3 M, less than, equal to, or greater than about 0.01 M, 0.02, 0.03, 0.04, 0.05, 0.06, 0.07, 0.08, 0.09, 0.1, 0.2, 0.3, 0.4, or about 0.5 M. The concentration of the complex in the anode can be in a range of from about 0.015 M to about 0.6 M, about 0.02 M to about 0.4 M, less than, equal to, or greater than about 0.015 M, 0.01, 0.02, 0.03, 0.04, 0.05, 0.06, 0.07, 0.08, 0.09, 0.1, 0.2, 0.3, 0.4, 0.5, or about 0.6 M.

In the battery, the anode solution is disposed within an anode tank 18. An anode reserve tank 20 is in flow communication with the anode tank 18. In order to maintain the proper amount of the complex in the anode tank excess complex can be pumped from the anode tank to the anode reserve tank. Conversely, if the amount of the complex in the anode tank is not sufficient, additional amounts of the complex can be pumped from the anode reserve tank to the anode tank.

In the battery, the cathode solution is disposed within a cathode tank 22. A cathode reserve tank 24 is in flow communication with the cathode tank 22. In order to maintain the proper amount of the complex in the cathode tank excess complex can be pumped from the cathode tank to the cathode reserve tank. Conversely, if the amount of the complex in the cathode tank is not sufficient, additional amounts of the complex can be pumped from the cathode reserve tank to the cathode tank.

To facilitate the flow of the complex in the anode or cathode solutions pumps 26 and 28 are respectively configured to create a flow of the anode solution between the anode tank and the anode reserve tank and to create a flow of the cathode solution between the cathode tank and the cathode reserve tank.

The battery can have a reversible cyclic voltammetry with a formal potential ranging from about −5 V to about 6 V versus a standard hydrogen electrode, about 0.5 V to about 4 V, less than about, equal to about, or greater than about −5V, −4.5, −4, −3.5, −3, −2.5, −2, −1.5, −1, 1, 1.5, 2, 2.5, 3, 3.5, 4, 4.5, 5, 5.5, or 6 V. According to various embodiments, the cyclic voltammetry of the battery remains substantially the same over a period ranging from about 2 cycles to about 1000 cycles, about 50 cycles to about 200 cycles, less than, equal to, or greater than 2 cycles, 50, 100, 150, 200, 250, 300, 350, 400, 450, 500, 550, 600, 650, 700, 750, 800, 850, 900, 950, or 1000 cycles.

The complex remains substantially stable throughout the cycles of the battery. This increases the lifespan of the battery as compared to a battery using a corresponding complex that is free of the ligand over a corresponding plurality of cycles.

The battery can receive electrical input from many suitable sources. Non-limiting examples of suitable sources include a photovoltaic array, a wind turbine or through a connection to an electrical grid. The batteries can also be used to store electricity.

In examples in which the metal is vanadium, the vanadium can be obtained in many suitable forms. However, high-purity vanadium can be very expensive and difficult to obtain. This can be because vanadium is present, in most cases, as a trace element that can be mined in conjunction with other minerals.

It has been surprisingly found that including the hexacyanoferrate complex increases the assessed capacity in the RTFB. Specifically, including hexacyanoferrate increases the assessed capacity in a comparative RTFB differing only in that it is free of the hexacyanoferrate. For example, relative to the comparative RTFB, the instantly disclosed RTFB has an assessed capacity in a range of from about 100% to about 200% greater than the comparative RTFB. As an example, the assessed capacity of the RTFB can be in a range of from about 4 mA·h to about 20 mA·h, about 5 mA·h to about 8 mA·h, less than, equal to, or greater than about 4 mA·h, 4.5, 5, 5.5, 6, 6.5, 7, 7.5, 8, 8.5, 9, 9.5, 10, 10.5, 11, 11.5, 12, 12.5, 13, 13.5, 14, 14.5, 15, 15.5, 16, 16.5, 17, 17.5, 18, 18.5, 19, 19.5, or about 20 mA·h.

### EXAMPLES

Various embodiments of the present invention can be better understood by reference to the following Examples which are offered by way of illustration. The present invention is not limited to the Examples given herein.

### Example 1

### Synthesis of tetrabutylammonium vanadium(iv)bis-hydroxyiminodiacetate

The VBH-based mediator ([TBA]₂[VBH]) was synthesized using the procedure reported in our recent study. The prepared solution was centrifuged at 1750 rpm for 25 min and filtered. Concentration was confirmed using UV-vis spectroscopy.

### Synthesis of Solid Charge Storage Material

CoHCF nanoparticles were synthesized. The two reagents required for the synthesis (Cobalt (II) nitrate [Co(NO₃)₂] and potassium hexacyanoferrate [K₃Fe(CN)₆]) were acquired from Strem Chemicals and Beantown Chemical, respectively. An aqueous solution of Co(NO₃)₂ was added dropwise to an aqueous solution of K₃Fe(CN)₆ under vigorous stirring for one hour until a molar ratio of Co:Fe was 3:2.67. During the stirring process, the mixture underwent an apparent color change to a dark brown and purple colloids were formed. The product was then centrifuged, washed with copious amounts of distilled water, dried in a Schlenk line for 36 hours and analyzed by IR spectroscopy.

CoHCF powder was compressed directly into pellets using a hydraulic press. During initial tests, the pellets were immediately breaking apart when submerged in MeCN. To maintain the mechanical integrity of the pellets required for cycling, CoHCF powder was mixed with polyvinylidene fluoride (PVDF) in n-methyl-2-pyrrolidone (NMP) solvent. Pellets were prepared using 80 wt % CoHCF and 20 wt % PVDF binder dissolved in NMP solvent. For each 100 mg CoHCF, 0.5 mL NMP was added into the solid/binder mixture. The solution was stirred in an aluminum plate and sonicated for 8 mins. Then, the plate was placed in a vacuum oven at a temperature of 100° C. The plate was left to dry in the oven overnight. A hydraulic die set was used to compress the dried material into pellets, where the structural stability was tested by placing the pellet in MeCN overnight. The weights of the pellets were measured before each use.

### Flow-Cell Experiment

The flow battery setup employed a flow-cell with two external tanks containing the [VBH] electrolyte solution in each half-cell (symmetrical flow-cell). The flow-cell was assembled using 2 layers of 250 μm carbon paper electrode (Av-Carb F250C—as received), 1 layer of 1/32″-thick silicone gaskets (McMaster Carr), and graphite bipolar plates with interdigitated flow fields on each side of the flow-cell. The electrodes (5 cm² geometric area) were compressed to ˜85% of their initial thickness when the flow-cell was fully assembled. Nafion XL was chosen as the membrane material and was soaked in MeCN for 24-hours before assembly of the flow-cell.

### UV-Vis Spectroscopy

The concentration and the state of charge (SOC) of both the positive and negative electrolytes were closely monitored using UV-vis spectroscopy (ThermoFisher Evolution 220) based on the extinction coefficients determined from literature, 25.2 M⁻¹·cm⁻¹ and 240.1 M⁻¹·cm⁻¹ for [VBH]²⁻/[VBH]¹⁻, respectively. Using the measured absorbance of the solution at the peak levels for vanadium(iv/v), 825 nm and 485 nm respectively, the estimated concentration of the solution can be determined through the Beer's law. Characterization of each of the half-cells was imperative to this study in order to monitor the stability of the active material (VBH) and to ensure that crossover of mediators through the separator does not contribute to the capacity improvement.

### Cyclic Voltammetry

Cyclic voltammograms (CVs) were recorded in a three-electrode electrochemical cell with a CoHCF coated graphite sheet as the working electrode, plain graphite sheet as the counter electrode and Ag/AgNO₃ (10 mM silver nitrate (AgNO₃) and 100 mM tetrabutylammonium hexafluorophosphate (TBAPF₆) in acetonitrile (MeCN) as the non-aqueous reference electrode. 50 mM TBAPF₆ was used as the electrolyte. The measurement was obtained between 1.2 V and −0.6 V at 5 mV/s scan rate. For the redox behavior of the mediator, similar CV measurements were conducted in a two-compartment H-cell with 50 mM [TBA]₂[VBH] solution in one side and 50 mM TBAPF₆ on the other side of the compartment. Plain graphite rods were used as the working and counter electrode. The potential at which the redox mediator ([VBH]²⁻/[VBH]¹⁻) undergoes redox reactions were determined and compared with the formal potential of the CoHCF determined from the CV measurement.

### Cation Intercalation Experiment

16.9 mM [TBA]₂[VBH] solution was prepared in MeCN. 4 vials were loaded with 3 mL of [TBA]₂[VBH] and 1 equivalent CoHCF. Variable amount of KPF6 were added (0, 0.12, 0.5, and 1.0 molar equivalent) to the vial 1 to 4. They were allowed to stir for 1 h and centrifuged at 7000 rpm for 10 min. UV-vis spectra were collected.

### Results and Discussion

### Energy Capacity Enhancement Using the ‘Teabag Approach’

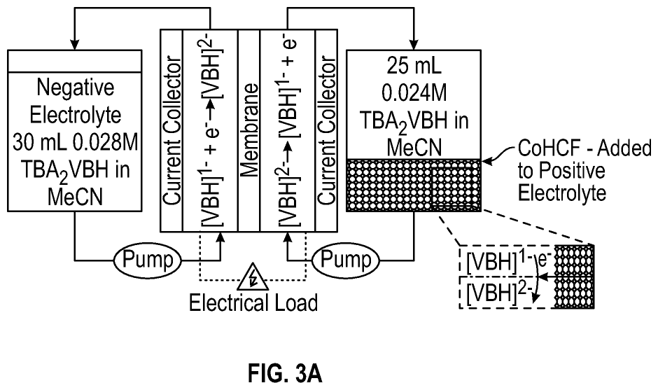

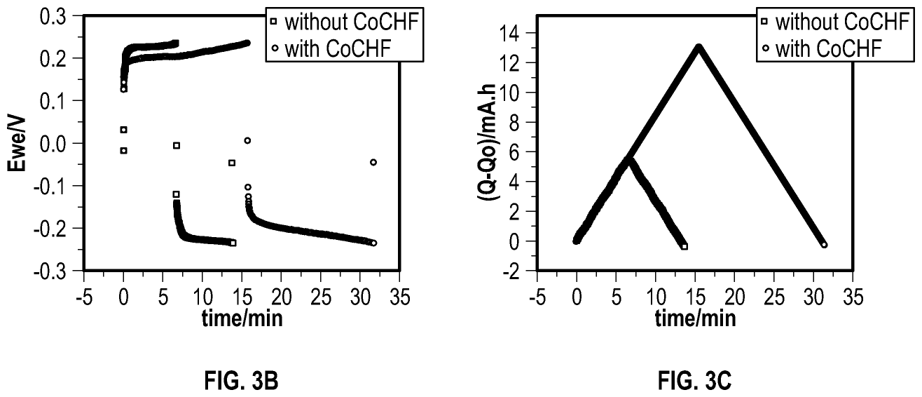

To validate the capacity booster behavior of the redox targeting approach, a symmetric flow-cell cycling experiment was designed. The benefits of using a symmetrical flow-cell are that it allows for the simultaneous charging and discharging of the redox active material, as there is only one redox couple present. Another important feature is that any potential crossover of the active material does not result in cross-contamination and thus avoids side reactions that may occur in the flow system. To ensure that any measured improvements in the energy density of the flow battery were solely due to the addition of the solid storage material, the positive side of the flow-cell setup was designed as the capacity limiting side and the solid charge storage material was only added into the positive tank (see FIG. 3a). For the cycling experiments, electrolytes with 50% SOC were placed in each tank. The electrolyte in the positive side was initially discharged by ˜25% at a constant current density of 10 mA·cm⁻². After this initial discharge process, the volumes were measured, and concentrations were determined using UV-vis. After verifying that the concentrations of each half-cell were within the specified ranges, ˜50% SOC-depth charge/discharge cycles were performed at a current density of 10 mA·cm⁻². Charge/discharge durations were initially determined by calculating the 50% capacity of the electrolytes. In order to directly compare the accessed capacity between the cases with and without the solid charge storage material, the cut-off voltage was adjusted between ±0.1-0.5 V after the first cycle so that the assigned cut-off voltage was achieved before the charge/discharge time was reached for both cases with and without the solid charge storage material. After the appropriate cut-off voltage was determined, the cycling process was continued until the charging capacity was stabilized. These steady-state data were used as the baseline for determining the improvement in energy density when solid storage material was added to the flow setup. When steady state was reached, the experiment was stopped, and volume and concentration measurements were taken. Subsequently, CoHCF was placed into the positive tank. The charge/discharge cycling was then continued using the same parameters described above—until steady state was once again reached—typically 8-10 cycles. After completion, the volume and concentration of the electrolytes were measured with UV-vis spectroscopy to detect any fluctuations in active material concentration.

The accessed capacity of the electrolyte (25 mL on the (+) side, 0.024 M [VBH] and 30 mL on (−) side, 0.028 M [VBH] in MeCN) was measured as 6.02 mA·h at the current density of 10 mA·cm⁻² with 0.235 V cut-off voltage. This corresponds to 37.4% of the 16.08 mA·h theoretical capacity of the electrolyte in the absence of CoHCF. Subsequently, 0.5 g of CoHCF were added to the positive electrolyte tank (capacity limited side) using a porous filter apparatus. A funnel was created using the filter and the CoHCF powder was placed into the funnel like a ‘teabag’. Upon cycling of the cell, the accessed capacity was found to be 13.09 mA·h with an increase of ˜120% compared to the base case (see FIG. 3b-c), corresponding to 81.4% of the theoretical capacity of the electrolyte alone. To confirm that the observed increase in capacity is not caused by crossover, the concentration of the positive electrolyte before and after the cycling tests was measured. Shown in Table 1 are the concentrations of active material present in both the positive and negative sides before and after charge/discharge cycling, with and without CoHCF added. Adjusting the maximum theoretical charge capacity by accounting for the losses in active material (0.60 mmol to 0.46 mmol), the capacity of the electrolyte just before the addition of CoHCF can be calculated as 12.22 mA·h. Based on the measured capacity after adding the solid material, the CoHCF utilization was determined to be ˜32%. This relatively lower utilization can be attributed to interaction limitations at the solid-liquid interface. Since the solid storage medium used for this experiment was placed in a filter, the most likely scenario is that not all of the CoHCF interacted with the VBH electrolyte. This limited interaction would still result in an increase in energy density for the system, but the measured value would be less than 50% of the theoretical maximum calculated.

TABLE 1
Volume, concentration, % SOC, and number of moles
for the positive and negative electrolytes with
and without the addition of CoHCF powder.

| | Without CoHCF | | With CoHCF | |
|---|---|---|---|---|
| | Positive- | Negative- | Positive- | Negative- |
| | Electrolyte | Electrolyte | Electrolyte | Electrolyte |
| Volume (mL) | 25 | 30 | 21.5 | 26 |
| Conc. (mM) | 24 | 28 | 21.2 | 36 |
| % SOC | 27% | 65% | 26% | 64% |
| Moles (mmol) | 0.60 | 0.84 | 0.46 | 0.94 |

### Energy Capacity Enhancement Using the ‘Pellet Approach’

As seen in Table 1, the volume of electrolyte at the positive side decreased slightly over cycling periods due to the relatively high volatility of acetonitrile and the electrolyte tanks not being fully enclosed when CoHCF was added. Additionally, since this setup employed a filter apparatus to prevent the solid material from circulating through the flow battery system, it was found to be difficult to optimize the electrolyte flow rate for achieving maximum interaction between the electrolyte and the solid charge storage material. Consequently, an additional set of experiments were performed, in which the solid charge storage material was added directly to the positive tank, allowing for maximum interaction between the mediator and charge storage materials and resulting in a higher CoHCF utilization. This was made possible by compressing the CoHCF into disc-shaped pellets that could be directly added to the positive tank.

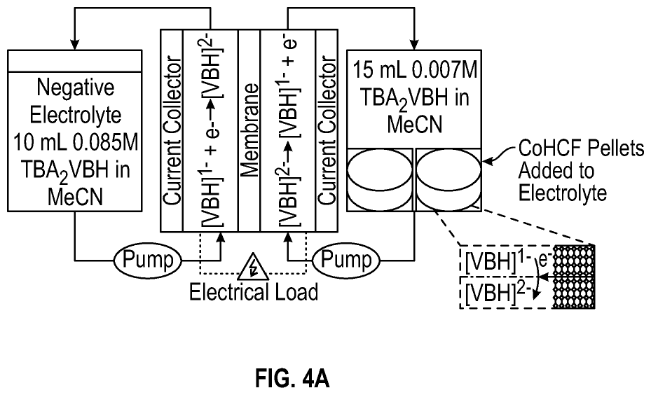

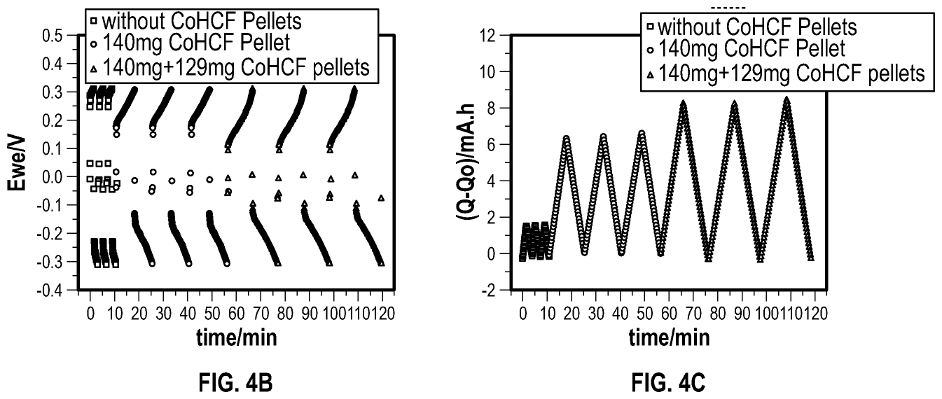

To provide further evidence that the addition of the solid storage material can surpass the solubility limitations that previously hindered redox flow batteries, similar charge/discharge cycling experiments were conducted using low concentration solutions. The starting solution contained 15 mL of 7 mM VBH electrolyte at the positive side and 9.5 mL of 83 mM electrolyte at the negative side. Since the moles of active material at the negative-side were significantly greater than the positive-side (7.5×-larger), crossover of active material would have a noticeable impact on the capacity of the system. For this reason, the theoretical capacity of the positive side in the absence of CoHCF was taken as the final value, after cycling, and should thus be considered a maximum throughout the experiment. Based on the starting volume and concentration of the positive electrolyte, the initial theoretical capacity of the system (100% SOC-depth) was 2.81 mA·h. However, considering the increased concentration measured after charge/discharge cycling without any pellets added (see Table 2), the final theoretical capacity was 4.88 mA·h. After addition of a 140 mg (80 wt % CoHCF) pellet, the observed capacity of the flow battery was 6.68 mA·h (see FIG. 4), an approximately 370% increase in capacity from the measured value without the pellet and 137% of the theoretical capacity of the positive electrolyte (see Table 3). The utilization of this pellet was calculated to be ˜80%.

TABLE 2
Concentration and volume measurements of the electrolytes before and after
charge/discharge cycling without added pellets, with the addition of
the~140 mg pellet (80% wt CoHCF, 20% wt PVDF), and with
the additional~129 mg pellet (95% wt CoHCF, 5% wt PVDF).

| | | | After 8 Cycles | | After 19 Cycles | | After 16 Cycles | |
|---|---|---|---|---|---|---|---|---|
| | | | (Before Adding | | (With 140 mg | | (With 140 mg + | |
| | Starting Point | | Pellets) | | Pellet) | | 129 mg Pellets) | |
| | Positive | Negative | Positive | Negative | Positive | Negative | Positive | Negative |
| Volume | 15 | 9.5 | 14 | 9.5 | 12.5 | 10.5 | 10 | 10.5 |
| (mL) | | | | | | | | |
| Conc. | 7.0 | 85 | 13 | 83 | 13.3 | 55 | 21 | 45 |
| (mM) | | | | | | | | |
| % SOC | 37% | 64% | 26% | 64% | 17% | 82% | 43% | 78% |
| Moles | 0.11 | 0.79 | 0.18 | 0.79 | 0.17 | 0.58 | 0.21 | 0.47 |
| (mmol) | | | | | | | | |

TABLE 3
Observed and theoretical capacities of the electrolyte
with and without the addition of the ~140 mg pellet
(80% wt CoHCF, 20% wt PVDF binder) and added ~129
mg pellet (95% wt CoHCF, 5% wt PVDF binder) to the
positive tank originally containing 15 mL of 7 mM VBH

| | | | Measured | Measured |
|---|---|---|---|---|
| | | | Volumetric | Molar |
| | Theoretical | Measured | Capacity | Capacity |
| | Capacity | Capacity | (mA · h · | (mA · h · |
| | (mA · h) | (mA · h) | mL⁻¹) | mmol⁻¹) |
| Without CoHCF | 4.88 | 1.41 | 0.10 | 7.83 |
| With 140 mg Pellet | 9.45 | 6.68 | 0.53 | 39.29 |
| With 140 mg + | 16.09 | 8.71 | 0.87 | 41.48 |
| 129 mg Pellets | | | | |
| Total Capacity | 11.21 | 7.30 | 0.77 | 33.65 |
| Added | | | | |

electrolyte.

Subsequently, a 129 mg (95 wt % CoHCF) pellet was added to the positive-side electrolyte, followed by charge/discharge cycling (using the same assigned cut-off voltage) until steady-state was achieved. With the addition of the second pellet (˜122.5 mg CoHCF) to the positive-side, the theoretical capacity of the flow battery system was increased by 5.47 mA·h. As seen in FIG. 4c, the capacity of the flow system after charge/discharge cycling with both pellets was observed as 8.71 mA·h (518% improvement in capacity). Using the calculated theoretical maximum capacity and the observed capacity with the added pellet, the CoHCF utilization for the two pellets together was determined to be ˜70%. The capacity improvement after the addition of the second pellet was determined to be ˜30% based on the measured capacities in Table 3. The observed capacity with the 140 mg pellet, estimated on a volumetric-, and molar-base, was then used to determine the capacity improvement from adding the second pellet. Adjusting the measured volumetric-, and molar-base capacities based on the volume and moles of active material measured after charge/discharge cycling with both pellets, the improvement was calculated to be 64% and 5.6%, respectively (see Table 3). The lower capacity improvement on the mole base is due to the increase in moles of active material, either due to crossover or from absorbed electrolyte in the pellet from previous experiments. After charge/discharge cycling with the two pellets added to the positive side was completed, volume and concentration measurements were taken, where it was once again observed that the moles of active material in the positive side increased over the cycling period. The increase in the moles of active material could either be from crossover due to the large gradient between the positive and negative sides or from some of the active material staying absorbed in the pellet from previous charge/discharge cycling experiment.

### Matching Standard Potentials Between the Mediator and the Solid Charge Storage Material

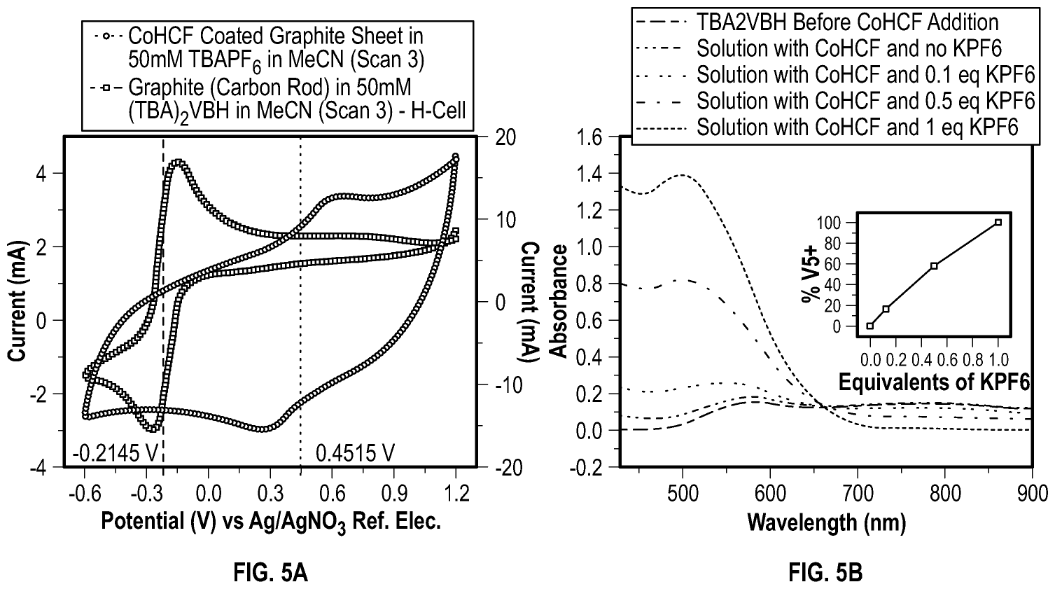

The operation of RTFBs requires two key processes in sequence: i) the mediators should be transported to a reaction site in the tank by means of convection and diffusion) and ii) an electron transfer (often coupled with another process such as, cation intercalation) has to be initiated. During the second process, the redox mediator provides the chemical overpotential needed to charge/discharge the active material. Thus, the mediator should provide a chemical potential sufficient to drive oxidation or reduction of the charge storage material. In certain cases, as seen in our system, it may be possible to drive both reactions with a single redox mediator, provided the formal potential of the redox mediator and the active material closely match. Surprisingly, and despite the fact that literature suggests that [TBA]₂[VBH] and CoHCF have similar reduction potentials (˜0.3 vs SHE), investigation of the cyclic voltammetry of the CoHCF and [TBA]₂[VBH] used to carry out the targeted-flow experiments showed a discrepancy between the standard potentials (see FIG. 5a). The apparent contradiction between the observed reversibility of the VBH/CoHCF target-flow system and the difference between observed formal potentials can be rectified by considering the effect of cation intercalation during CoHCF reduction. It is clear from the literature that the standard potential of redox intercalation changes considerably depending on the size of counter cation. For example, Sinha et al. reports an approximately 480 mV positive shift for NiHCF going from small, Li⁺ cations to large, Cs⁺ cations. Furthermore, a recent, combined, Raman, in-situ, powder X-Ray diffraction study showed that reduction of A[Fe³⁺Fe²⁺(CN)₆], where A=Na⁺ or K⁺ follows a solid-solution mechanism, where the reduction potential varies smoothly as the lattice expands during cation intercalation, in the case of Na⁺, but undergoes a sharp transition to a second crystal phase, in the case of K⁺ intercalation. We also note that the stoichiometry of CoHCF is promiscuous, and prone to small variations, including the incorporation of small amounts of K⁺ carried over during synthesis. We hypothesized that even substoichiometric quantities of adventitious K⁺ could modulate the formal potential of CoHCF, establishing an equilibrium between reduced and oxidized VBH that accounts for the observed reversibility. To investigate this, samples of 17 mM [TBA]₂[VBH] in acetonitrile were stirred for one hour with one equivalent of CoHCF and quantities of KPF₆ ranging from zero to one equivalent. As shown in FIG. 5b, in the absence of added K⁺, a stirred solution of V⁴⁺BH is stable, experiencing less than 1% oxidation to V⁵⁺BH. Additional quantities of KPF₆ gradually shift the V^{4+/5+} equilibrium until quantitative oxidation to V⁵⁺BH is observed after addition of one equivalent of KPF₆. To verify the presence of K⁺ in the CoHCF powder synthesized, IR spectra of contaminated CoHCF, pure CoHCF, KNO₃, and the subtraction of contaminated CoHCF—pure CoHCF were obtained and shown in FIG. 6. Since the subtracted IR spectrum looks identical to the spectrum of KNO₃, it is evident that KNO₃ is present in the CoHFC powder.

Using the high stability [VBH] active material coupled with CoHCF as the solid charge storage material allowed for the energy density of the flow battery to be greatly improved. To determine the capacity improvements during cycling made by CoHCF on the flow system, a cut-off voltage was assigned based on the potential observed at 50% SOC-depth of the capacity limiting side (positive electrolyte) without CoHCF. This ensured that when CoHCF was added to the positive side that the observed capacity could be directly compared to the measured capacity of the flow battery without CoHCF. Since the cut-off voltage remained constant with and without CoHCF, i.e., the same boundary conditions were applied, any capacity improvement would therefore be a direct result of the addition of the solid material.

The initial design for the redox mediation concept was based on a flow through concept, which operated by having the oxidized electrolyte at the positive side flowing through the solid charge storage material (teabag approach). Although evidence has shown that this design improved the energy density of the system, many parameters needed to be controlled which increased the complexity of the system. Therefore, an alternative approach was devised which focused on the direct addition of CoHCF to the positive side to reduce complexity while still maintaining a high interaction at the solid-liquid interface. In this method, CoHCF powder was compressed into 10 mm diameter pellets that could be directly added to the positive tank (pellet approach)—a far less complex approach than the previously mentioned flow through concept. These pellets were capable of utilizing up to the ˜70% of the available capacity from CoHCF and improve the energy density by ˜5×. As more pellets were added to the positive side, the capacity of the flow battery was found to increase further, meaning that the capacity is limited by the amount of solid charge storage material in the electrolyte tank and their utilization with the electrolyte. Sufficient evidence has indicated that this redox mediation concept makes it possible to surpass the solubility limitations of the active material, allowing for unprecedented improvements to the energy density of RFBs. Furthermore, observations obtained from the cation intercalation experiment, taken together with the reversibility of the VBH/CoHCF system, demonstrate that an empirical approach to matching RTFB mediators with solid charge storage materials may be most effective. Furthermore, they suggest a promising strategy for optimizing RTFB performance, by altering the ratio of a combination of supporting cations with variousintercalation potential, which is currently under investigation.

### Example 2

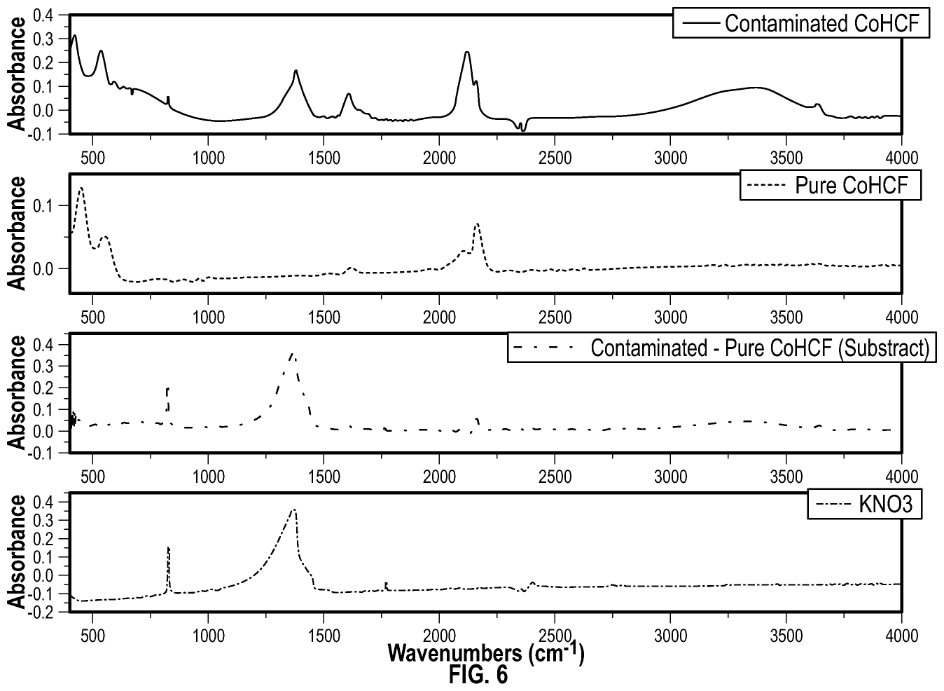

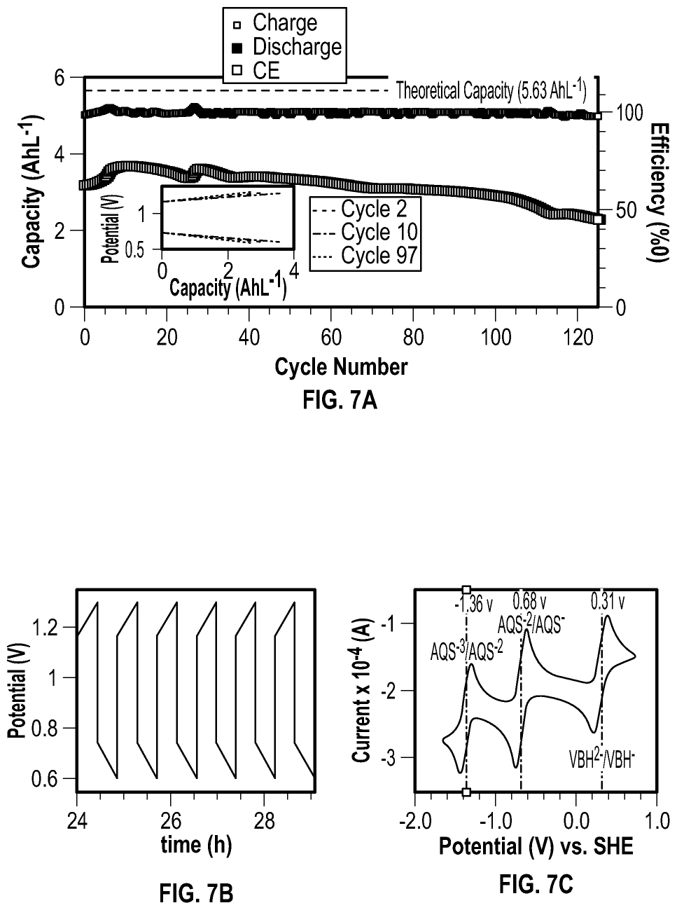

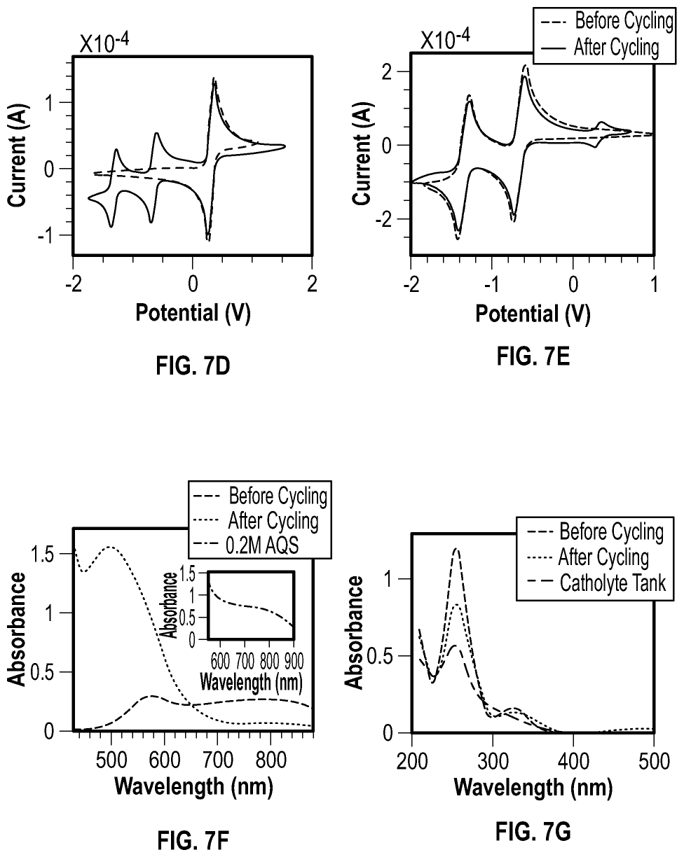

Anthraquinone 2-sulfonate (AQS) was studied as an anolyte counterpart for VBH catholyte, in a mixed-electrolyte to be paired with solid booster materials, due to its permanent negative charge in the discharged state (FIG. 7). As such, both active materials cycle between 2⁻ and 1⁻ oxidations states, while their as-prepared tetrabutylammonium cations shuttle through the ionomer membrane to maintain charge neutrality. This eliminates the need to add high concentration supporting salt. It was demonstrated that the solubility of AQS can be improved by utilizing tetraalkylammonium cations (Table 4), in a strategy similar to that reported for VBH. It is also shown that electrochemical studies of the individual active materials in symmetric cells and combined in a full-cell.

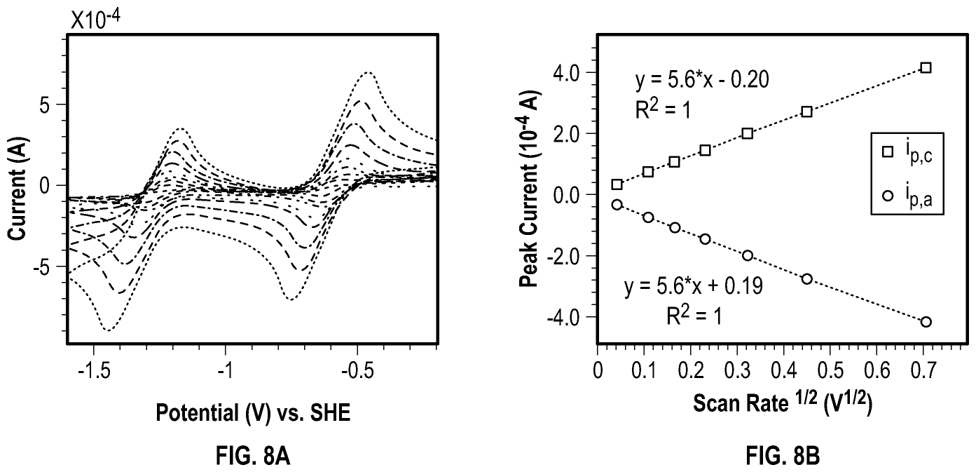

The electrochemical behavior of AQS was evaluated using cyclic voltammetry (FIG. 8). AQS exhibits two electrochemically reversible waves centered on −0.6 V and −1.2 V vs SHE. Based on the electrochemistry of similar quinones in organic solvent, the two waves correspond to formation of 1⁻/2⁻ and 2⁻/3⁻ redox couples, respectively, in two separate single electron redox processes. CV at various scan rates were collected and the peak current were plotted against square root of scan rate (Randles-Sevcik plot) (FIG. 8). A linear dependence of peak height to square root of scan rate with a zero-intercept (FIG. 8b) indicates a diffusion-controlled electrode reaction. The diffusion coefficient was found to be 8.46×10⁻⁶ cm² s⁻¹, which is comparable to that of other AQ derivatives reported in literature. When paired with VBH, the AQS-VBH full cell displays an open-circuit potential of >1.1 V at 90% state of charge (SOC) (E°_{VBH}=0.30 V vs. SHE in DMSO⁴⁵).

As shown in FIG. 7, the mixture of AQS and VBH is electrochemically compatible, and resulting full cell exhibits an OCV of ˜1 V. The battery was charged and discharged at 18 mA cm⁻² current density with potential cut-off at 1.3 V and 0.6 V respectively. During charging, VBH²⁻ is oxidized into VBH⁻ whereas AQS⁻ is reduced into radical dianion AQS⋅²⁻.

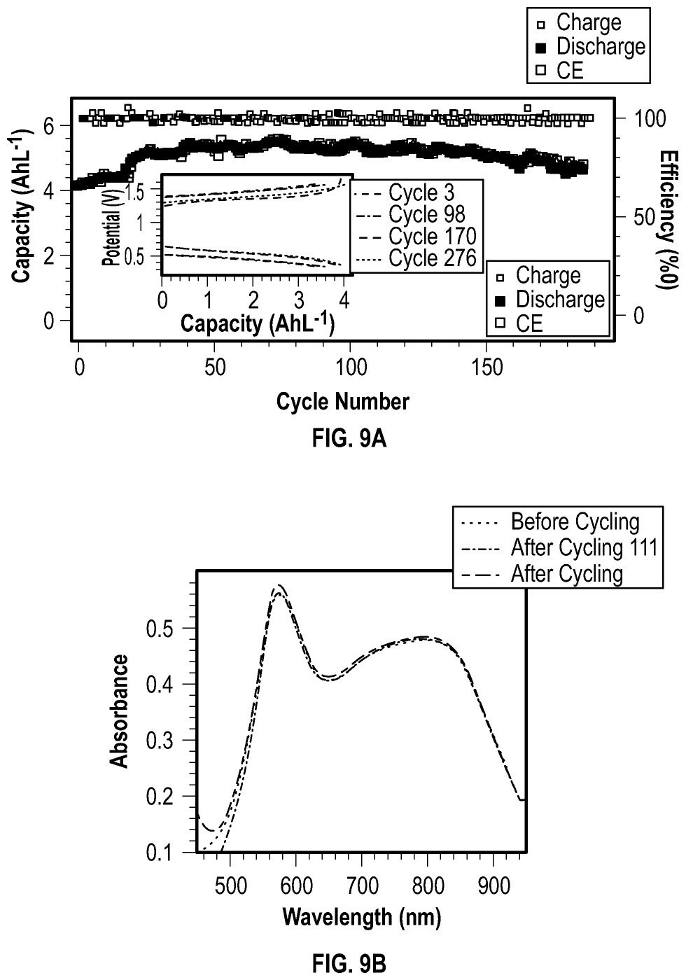

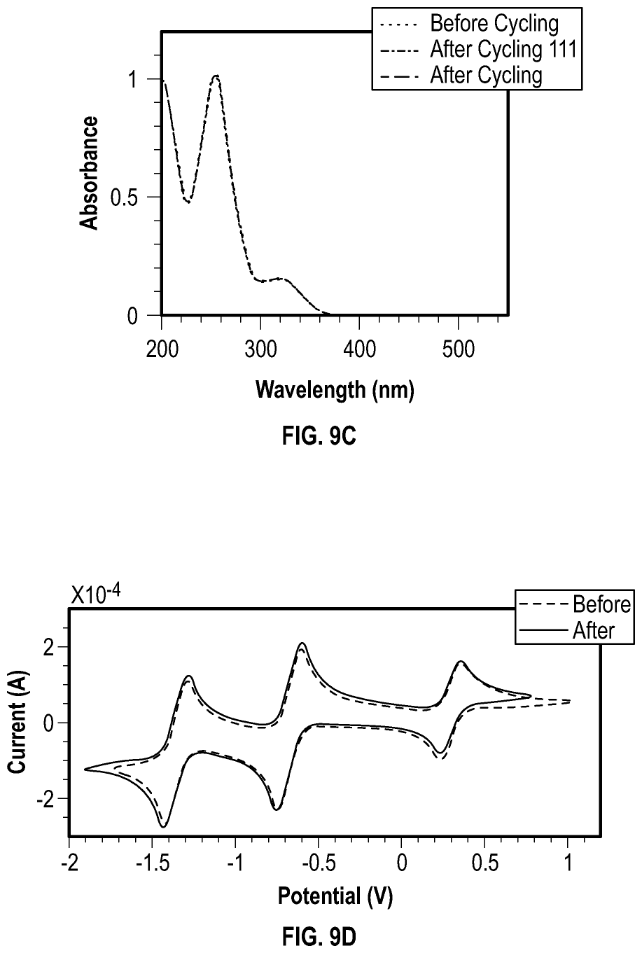

To minimize deleterious effects of crossover, and considering the compatibility of VBH and AQS, we have evaluated a mixed-electrolyte system, comprising TBA₂ VBH and TBAAQS as both catholyte and anolyte using Nafion 117 (FIG. 9). Over the course of 190 cycles (6.8 days) a maximum capacity of 5.4 Ah L⁻¹, corresponding to 72% of theoretical capacity was accessed. Charge-discharge capacity gradually increased for ˜50 cycles and then decreased steadily to 4.5 Ah L⁻¹, retaining 84% of the maximum capacity achieved. Thus, the mixed electrolyte cell configuration displayed capacity fade rate of 0.138% per cycle or 0.180% per hour (as opposed to 0.29% per cycle or 0.39% per hour in asymmetric configuration) which is likely due to the asymmetric crossover of the active-materials. Overlaid UV-vis spectra of electrolytes indicate no significant change in features and absorbance of spectra of either catholyte or anolyte suggesting that there is no active material decomposition.

### Chemicals and Manipulations

Tetrabutylammonium fluoride trihydrate (Oakwood chemicals), tetrabutylammonium hexafluorophosphate (Oakwood chemicals), sodium anthraquinone-2-sulfonate (TCI), anhydrous acetonitrile (Sigma Aldrich), diethyl ether, tetrahydrofuran (VWR), ferrocenium hexafluorophosphate (Sigma Aldrich) were purchased from commercial source. Tetrabutylammonium hexafluorophosphate was recrystallized twice from ethanol/water and dried in vacuo at 80° C. for 12 h. NMR solvents were purchased from Isotope Laboratories and Nafion membranes were purchased from Fuel Cell Store. All electrochemical tests were carried out in an inert atmosphere of dinitrogen (<5 ppm O₂ and <1 ppm H₂O) in a glove box. Anhydrous solvents were used as received. ¹H and ¹³C NMR spectra were recorded on Bruker AVANCE III HD 400 MHz High-Performance Digital NMR spectrometer; ¹H (400 MHz), ¹³C (101 MHz). All ¹H and ¹³C NMR chemical shifts are reported in ppm relative to TMS and referenced to chemical shifts of the solvent or TMS as a standard. IconNMR 5.0.3 and TopSpin 3.5 were used for data acquisition and processing. Infrared spectroscopy was conducted on a ThermoNicolet iS5 equipped with iD7ATR module and a diamond crystal. High Resolution Mass Spectrometry (HRMS) were collected on a Waters Xevo QTOF-I spectrometer using electrospray ionization. X-ray crystallographic experiments were performed on a Bruker D8 Venture X-instrument, using Mo Kα radiation at 200 K. Data were corrected for absorption using SADABS. The structures were solved by direct methods (SHELXS). All non-hydrogen atoms were refined anisotropically by full matrix least squares on F² and all hydrogen atoms except those on water were placed in calculated positions with appropriate riding parameters. Further refinement and molecular graphics were obtained using Bruker Suite of structural programs, and OLEX2.

### Synthesis

TBA₂VBH was synthesized by reacting tetrabutylammonium fluoride with CaVBH. Detailed synthesis of ZnHIDA ligand and CaVBH are previously reported in literature.⁶ IR (ν, cm⁻¹): 609, 910, 1124, 1364, 1625, 2960

TBA₂VBH was chemically oxidized to TBAVBH using ferrocenium hexafluorophosphate (FcPF6). Synthetic procedure detailed in above reference was followed. δ _{H} (400 MHz, CD₃CN) 4.97 (2H, d, J 16.1), 4.71 (2H, d, J 16.1), 4.61 (2 H, d, J 16.1), 4.44 (2H, d, J 16.1), 3.11 (8H, t, J 8.5), 1.63 (8H, p, J 7.9), 1.38 (8H, h, J 7.4), 0.99 (12H, t, J 7.3). δ _{C} (101 MHz, CD₃CN) 170.69, 170.28, 65.39, 64.72, 58.91, 58.89, 58.86, 23.87, 19.92, 19.90, 19.88, 13.38. UV-Vis (MeCN): λₘₐₓ=497 nm (ε=240 mol⁻¹ cm⁻¹).

In a vial, sodium salt of anthraquinone-2-sulfonate (3.39 g, 0.0109 mol) and tetraethylammonium fluoride (1.6 g, 0.0106 mol) was mixed with 50 mL acetonitrile and stirred 1 h. The precipitate was removed by filtration and the solvent was evaporated under reduced pressure. Product was recrystallized from saturated solution in acetonitrile. Yield 3.32 g, 75%. δ _{H} (400 MHz, D₂O) 7.65 (1H, dd, J 8.0, 1.8), 7.55 (1H, d, J 1.8), 7.31 (1H, d, J 8.0), 7.15-6.94 (4H, m), 3.18 (8H, q, J 7 .3), 1.18 (12H, tt, J 3.6, 1.9). δ _{C} (101 MHz, CDCl₃) 182.75, 182.70, 152.74, 134.22, 134.18, 133.58, 133.55, 133.37, 131.78, 127.59, 127.30, 127.20, 124.91, 52.68, 52.65, 52.62, 7.69. IR (ν, cm⁻¹): 572.92, 657.72, 704.02, 1032.44, 1169.22, 1204.93, 1289.98, 1672.03. UV-Vis (MeCN): λₘₐₓ=256 nm (ε=36400 mol⁻¹ cm⁻¹).

Sodium salt of anthraquinone-2-sulfonate (2.29 g, 0.00739 mol) and tetra-n-propylammonium fluoride (1.51 g, 0.00739 mol) was reacted in acetonitrile. The reaction mixture was centrifuged and liquid was collected which was then dried under reduced pressure. The product was recrystallized from acetonitrile/THF mixture. Yield 2.44 g, 69%. δ H (400 MHz, CDCl3) 8.79 (1H, dd, J 1.7, 0.5), 8.42-8.16 (4H, m), 7.86-7.72(2H, m), 3.30 (8H, t, J 8.5), 1.87-1.62 (8H, m), 1.03 (12H, t, J 7.3). δ C (101 MHz, CDCl3) 182.84, 182.70, 153.04, 134.10, 133.68, 133.60, 133.50, 133.36, 131.94, 127.47, 127.27, 127.21, 125.13, 60.65, 15.75, 10.85. IR (ν, cm⁻¹): 619.05, 657.05, 709.49, 717.59, 1032.47, 1206.34, 1289.68, 1665.19. UV-Vis (MeCN): λₘₐₓ=256 nm (ε=35200 mol⁻¹ cm⁻¹).

To a suspension of sodium anthraquinone-2-sulfonate (10.0 g, 0.0323 mol) in 30 mL acetonitrile, tetrabutylammonium fluoride (10.16 g, 0.0323 mol) was added and stirred for 1 h. The reaction mixture was centrifuged at 3000 rpm for 15 min and decanted. Solvent was evaporated under reduced pressure to isolate yellow solid which was then recrystallized from MeCN/diethyl ether solvent. Yield 14.6 g, 86% δ _{H} (400 MHz, CDCl₃) 8.92-8.59 (1H, m), 8.36 -8.23 (4H, m), 7.79 (2H, ddd, J 7.3, 5.8, 3.3), 3.35-3.23 (8H, m), 1.65 (8H, ddt, J 14.1, 10.2, 6.3), 1.40 (8H, dh, J 14.5, 7.5), 0.95 (12H, t, J 7.1). δ _{C} (101 MHz, CD₃CN) 183.28, 183.13, 154.59, 134.98, 134.95, 134.13, 134.05, 133.90, 131.88, 127.68, 127.40, 127.37, 124.55, 58.87, 58.84, 58.81, 23.88, 19.91, 19.88, 13.39, 1.52, 1.31. IR (ν, cm⁻¹): 620.11, 1031.64, 1210.80, 1285.91, 1671.48, 2964. UV-Vis (MeCN): λₘₐₓ=256 nm (ε=35040 mol⁻¹ cm⁻¹).

Beer's law was used to measure the concentration of the solution using pre-determined molar extinction coefficient using standard calibration curve. (molar extinction coefficient for VBH, ε (825 nm)=25.0 and for AQS ε (256 nm)=35040 mol⁻¹ cm⁻¹. To measure the solubility of TBAAQS, excess TBAAQS was added to 0.5 mL MeCN and stirred at 40° C. for 15 min. Then the solution was cooled to room temperature and centrifuged. UV-vis sample was prepared by serial dilution of the solution. UV-VIS spectra were collected with a Evolution 220 UV-visible Spectrophotometer (Thermo Scientific) using a quartz cuvette of 1 cm path length.

. Crossover tests were carried out in static H-cell setup with active species (0.2 mol L⁻¹ in MeCN) in charged, discharged, or 50% SOC. H-cell assembly was made using the pre-soaked membrane. One side of the H-cell was filled with 10 mL 0.2 M active species while counter side of the H-cell was filled with TBAPF₆ solution in MeCN. To avoid solvent transport due to concentration gradient, the concentration of TBAPF₆ was calculated such that the ionic strength of both halves is equal. To allow the membrane to equilibrate, the setup with solution was let to sit for 3-4 h after assembly, after which the counter side solution was replaced with fresh solution then qualitative measurement were performed. Content of both sides were stirred throughout the experiment with brief pause during CV measurement. The crossover concentration of VBH²⁻ (discharged), VBH⁻ (charged) and 50% mixture of VBH²⁻/VBH⁻ was analyzed using UV-vis spectroscopy by taking a 2 mL sample from the counter-side of the cell and placing it in a 1 cm quartz cuvette. After the spectral measurement the sample was placed back into the H cell.

To measure the crossover concentration of AQS in both reduced and oxidized state, cyclic voltammetry was used. Three electrode CV setup was fitted to the counter side of H-cell. (Glassy carbon as working electrode, silver wire as pseudo-reference electrode and Pt wire as counter electrode, supporting electrolyte was TBAPF₆ in MeCN of equal ionic strength). CV was performed in a loop with time delay of 1 h. The cathodic and anodic peak heights were used to calculate the crossover concentration using standard calibration curve constructed from peak height of the CV of known concentration AQS solutions. Further, two separate samples of AQS during CV experiment were analyzed using UV-Vis spectroscopy to verify the concentration.

Cyclic voltammetry was performed at room temperature in inert atmosphere of dinitrogen using three electrode cell on a VersaSTAT3 workstation. (Princeton Applied Research, USA). Glassy carbon (3 mm, Basi) was employed as working electrode and platinum wire was used as counter electrode. Ag wire was used as pseudo reference electrode with Fc/Fc⁺ couple as an internal standard for initial redox potential evaluation. Subsequently, all potentials were referenced to SHE. Diffusion coefficient was calculated using Randles-Sevcik equation as follow.

$${i}_{p} = 0.4463 {nFAC ( \frac{nFvD}{RT} )}^{\frac{1}{2}} \qquad ( )$$

where, iₚ is the peak current, n is number electron in redox reaction, F is faraday constant, A is geometrical surface area of electrode, C is the bulk concentration of analyte, ν is scan rate, D is diffusion coefficient and R and T are gas constant and absolute temperature. CV curves were obtained at various scan rate and peak current were plotted against square root of scan rate. Slope (m) of the linear fit was used to determine diffusion coefficient using following equation.

$$D = {( \frac{m}{04 \; 463 nFAC} )}^{2} \frac{R T}{n F} . \qquad ( )$$

### Flow Cell Tests

Flow cell for both symmetric and full cell were constructed in the following manner. Two layer of carbon cloth electrodes (Avcarb) and one layer of 1/32″ silicone gasket on each side, separated by one layer of either Nafion 115 or Nafion 117 membrane were compressed between graphite bipolar plate with interdigitated flow field and gold-plated current collector. The active surface area of the flow field was 5 cm². Electrolyte reservoir were connected to the cell using assembly of PTFE and Viton tubing. Electrolytes were circulated at the flow rate of 40 mL/min using Masterflex L/S peristaltic pump from Cole-Parmer. The cell was galvanostatically charged-discharged at various current densities using a VersaSTAT3 workstation (Princeton Applied Research, USA). All flow experiments were conducted at 18-20° C. except the high-concentration flow cell, which was conducted at 30-35° C. For the symmetric AQS cell, 50% SOC electrolyte was prepared by galvanostatically charging 15 mL of TBA AQS electrolyte completely using TBA₂VBH as sacrificial reductant on counter side and mixing with equal volume of initial electrolyte. For symmetric VBH cell, 50% solution of desired concentration was prepared by dissolving each of TBA₂VBH (reduced) and chemically oxidized TBAVBH in acetonitrile. No supporting salt were used in any of the flow cell testing.

TABLE 4

| Ionic derivatives | Solubility (M) | Capacity (AhL⁻¹) (2 e⁻) |
|---|---|---|
| AQ | <0.005 | |
| NaAQS | <0.001 | |
| N₂₂₂₂AQS | 0.105M | 5.62 |
| N₃₃₃₃AQS | 0.64M | 34.4 |
| N₄₄₄₄AQS | 1.26M | 67.55 |

The terms and expressions that have been employed are used as terms of description and not of limitation, and there is no intention in the use of such terms and expressions of excluding any equivalents of the features shown and described or portions thereof, but it is recognized that various modifications are possible within the scope of the embodiments of the present invention. Thus, it should be understood that although the present invention has been specifically disclosed by specific embodiments and optional features, modification and variation of the concepts herein disclosed may be resorted to by those of ordinary skill in the art, and that such modifications and variations are considered to be within the scope of embodiments of the present invention.

### Exemplary Embodiments

The following exemplary embodiments are provided, the numbering of which is not to be construed as designating levels of importance:

Aspect 1 provides a redox flow battery comprising:
an anode in communication with a current collector and comprising a first solid charge storage medium disposed within the anode; and
   a cathode in communication with the current collector and comprising a second solid charge storage medium disposed within the cathode, wherein
   at least one of the anode, current collector, or cathode comprises a complex dispersed therein, the complex having a structure according to Formula I:

[ML₂]ₘ⁻²[CAT]ₙ⁺² (I),
wherein,
   M is metal;
   L is a ligand has a structure according to Formula II:

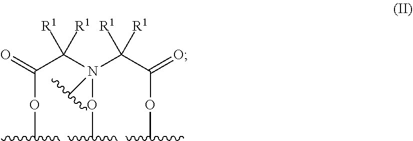

at each occurrence R¹ is independently chosen from —H, substituted or unsubstituted (C₁-C₁₀)hydrocarbyl, —F, —Cl, —Br, and —I;
n and m are independently 1 to 10;
CAT is a cation having the metal in a first oxidation state when the complex is dispersed in the anode and the metal is in a second oxidation state when the complex is dispersed in the cathode; and
optionally at least one of the anode, current collector, or cathode further comprises anthraquinone 2-sulfonate; and
optionally at least one of anode, current collector, or cathode further comprises one or more hexacyanometalates.

Aspect 2 provides the redox flow battery of Aspect 1, wherein the metal is a transition metal optionally chosen from V, Cr, Mn, Fe, Co, Ni, Cu, or Zn.

Aspect 3 provides the redox flow battery of any one of Aspects 1 or 2, wherein the metal is at least one of V(iv) and V(v).

Aspect 4 provides the redox flow battery of any one of Aspects 1-3, wherein the cation is chosen from Ca⁺², 2Li⁺, 2NMe⁺, (NMe₄⁺/H₅O₂⁺), 2Na⁺, 2K⁺, Be⁺2, and Mg⁺².

Aspect 5 provides the redox flow battery of any one of Aspects 1-4, wherein at each occurrence R¹ is —H.

Aspect 6 provides the redox flow battery of any one of Aspects 1-5, wherein at each occurrence R¹ is (C₁-C₁₀)alkyl.

Aspect 7 provides the redox flow battery of any one of Aspects 1-6, wherein at each occurrence R¹ is —F.

Aspect 8 provides the redox flow battery of any one of Aspects 1-7, wherein the complex has a coordination number of 8.

Aspect 9 provides the redox flow battery of any one of Aspects 1-8, wherein the complex has the structure according to Formula (III):

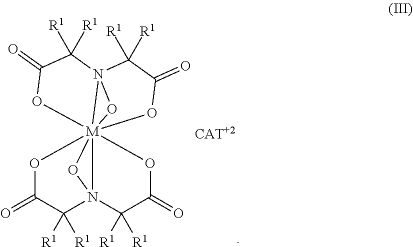

Aspect 10 provides the redox flow battery of any one of Aspects 1-9, wherein the complex has the structure according to Formula (IV):

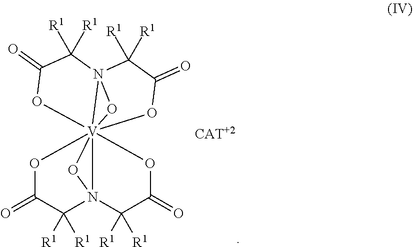

Aspect 11 provides the redox flow battery of any one of Aspects 1-10, wherein the complex has the structure according to Formula (V):

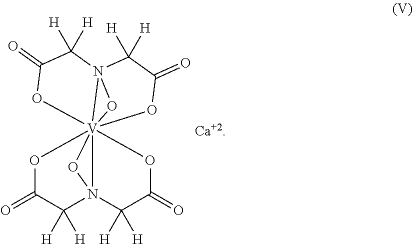

Aspect 12 provides the redox flow battery of any one of Aspects 1-11, wherein the complex has the structure according to Formula (VI):

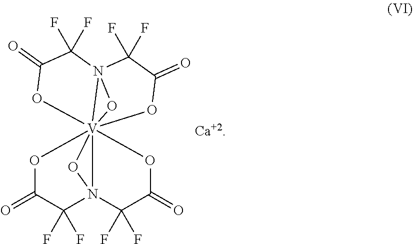

Aspect 13 provides the redox flow battery of any one of Aspects 1-26, wherein the second solid charge storage medium comprises a hexacyanoferrate complex.

Aspect 14 provides the redox flow battery of Aspect 13, wherein the hexacyanoferrate comprises cobalt hexacyanoferrate, potassium hexacyanoferrate, or a mixture thereof.

Aspect 15 provides the redox flow battery of any one of Aspects 1-14, wherein the hexacyanoferrate comprises cobalt hexacyanoferrate.

Aspect 16 provides the redox flow battery of any one of Aspects 1-15, wherein a concentration of the complex in the cathode is in a range of from about 0.01 M to about 0.5 M.

Aspect 17 provides the redox flow battery of any one of Aspects 1-16, wherein a concentration of the complex in the cathode is in a range of from about 0.02 M to about 0.3 M.

Aspect 18 provides the redox flow battery of any one of Aspects 1-17, wherein a concentration of the complex in the anode is in a range of from about 0.015 M to about 0.6 M.

Aspect 19 provides the redox flow battery of any one of Aspects 1-18, wherein a concentration of the complex in the anode is in a range of from about 0.02 M to about 0.4 M.

Aspect 20 provides the redox flow battery of any one of Aspects 13-19, wherein an assessed capacity of the redox flow battery is in a range of from about 100% to about 200% greater than a comparative battery differing only that it is free of the hexacyanoferrate complex.

Aspect 21 provides the redox flow battery of any one of Aspects 1-20, wherein the assessed capacity is in a range of from about 4 mA·h to about 20 mA·h.

Aspect 22 provides the redox flow battery of any one of Aspects 1-21, wherein an assessed capacity is in a range of from about 5 mA·h to about 8 mA·h.

Aspect 23 provides the redox flow battery of any one of Aspects 1-22, further comprising:
a first pump in communication with the anode and the current collector; and
a second pump in communication with the cathode and current collector.

Aspect 24 provides the redox flow battery of any one of Aspects 13-23, wherein the anode is free of the hexacyanoferrate complex.

Aspect 25 provides the redox flow battery of any one of Aspects 1-24, wherein the anode further comprises a negative electrolyte solution.

Aspect 26 provides the redox flow battery of any one of Aspects 1-25, wherein the cathode further comprises a positive electrolyte solution.

Aspect 27 provides the redox flow battery of any one of Aspects 1-26, wherein each of the anode, current collector, or cathode comprises the complex dispersed therein.

Aspect 28 provides a solid charge storage material comprising anthraquinone 2-sulfonate, the complex having a structure according to Formula I of any one of claims 1-27, or a mixture thereof.

What is claimed is:

1. A redox flow battery comprising:
an anode in communication with a current collector and comprising a first solid charge storage medium disposed within the anode; and
a cathode in communication with the current collector and comprising a second solid charge storage medium disposed within the cathode, wherein
at least one of the anode, current collector, or cathode comprises a complex dispersed therein, the complex having a structure according to Formula I:
[ML₂]ₘ⁻²[CAT]ₙ⁺² (I),
wherein,
M is metal;
L is a ligand has a structure according to Formula II: 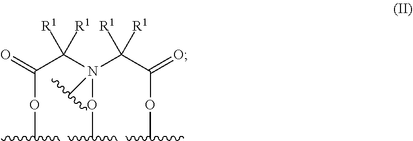
at each occurrence R¹ is independently chosen from —H, substituted or unsubstituted (C₁-C₁₀)hydrocarbyl, —F, —Cl, —Br, and —I;
n and m are independently 1 to 10;
CAT is a cation having the metal in a first oxidation state when the complex is dispersed in the anode and the metal is in a second oxidation state when the complex is dispersed in the cathode;
optionally at least one of the anode, current collector, or cathode further comprises anthraquinone 2-sulfonate; and
optionally at least one of anode, current collector, or cathode further comprises one or more hexacyanometalates.

2. The redox flow battery of claim 1, wherein the metal is a transition metal optionally chosen from V, Cr, Mn, Fe, Co, Ni, Cu, or Zn.

3. The redox flow battery of claim 1, wherein the metal is at least one of V(iv) and V(v).

4. The redox flow battery of claim 1, wherein the cation is chosen from Ca⁺², 2Li⁺, 2NMe⁺, (NMe₄⁺/H₅O₂⁺), 2Na⁺, 2K⁺, Be⁺², and Mg⁺².

5. The redox flow battery of claim 1, wherein at each occurrence R¹ is —H.

6. The redox flow battery of claim 1, wherein at each occurrence R¹ is (C₁-C₁₀)alkyl.

7. The redox flow battery of claim 1, wherein at each occurrence R¹ is —F.

8. The redox flow battery of claim 1, wherein the complex has a coordination number of 8.

9. The redox flow battery of claim 1, wherein the complex has the structure according to Formula (III):

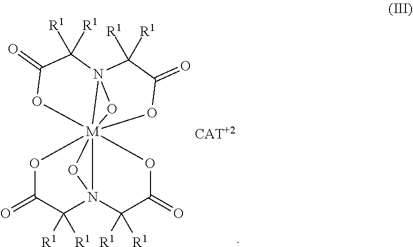

10. The redox flow battery of claim 1, wherein the complex has the structure according to Formula (IV):

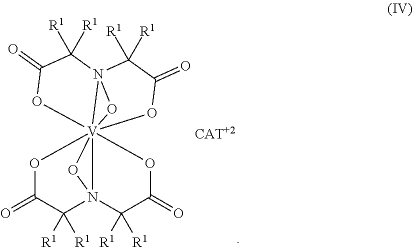

11. The redox flow battery of claim 1, wherein the complex has the structure according to Formula (V):

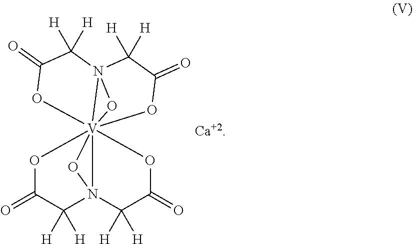

12. The redox flow battery of claim 1, wherein the complex has the structure according to Formula (VI):

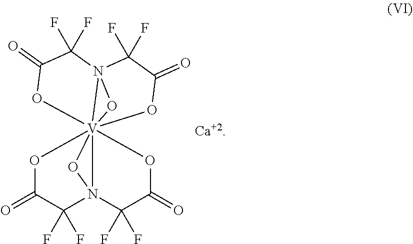

13. The redox flow battery of claim 1, wherein the second solid charge storage medium comprises a hexacyanoferrate complex.

14. The redox flow battery of claim 13, wherein the hexacyanoferrate comprises cobalt hexacyanoferrate, potassium hexacyanoferrate, or a mixture thereof.

15. The redox flow battery of claim 1, wherein the hexacyanoferrate comprises cobalt hexacyanoferrate.

16. The redox flow battery of claim 1, wherein a concentration of the complex in the cathode is in a range of from about 0.01 M to about 0.5 M.

17. The redox flow battery of claim 1, wherein a concentration of the complex in the cathode is in a range of from about 0.02 M to about 0.3 M.

18. The redox flow battery of claim 1, wherein a concentration of the complex in the anode is in a range of from about 0.015 M to about 0.6 M.

19. The redox flow battery of claim 1, wherein a concentration of the complex in the anode is in a range of from about 0.02 M to about 0.4 M.

20. The redox flow battery of claim 13, wherein an assessed capacity of the redox flow battery is in a range of from about 100% to about 200% greater than a comparative battery differing only that it is free of the hexacyanoferrate complex.

21. The redox flow battery of claim 1, wherein the assessed capacity is in a range of from about 4 mA·h to about 20 mA·h.

22. The redox flow battery of claim 1, wherein an assessed capacity is in a range of from about 5 mA·h to about 8 mA·h.

23. The redox flow battery of claim 1, further comprising:
a first pump in communication with the anode and the current collector; and
a second pump in communication with the cathode and current collector.

24. The redox flow battery of claim 13, wherein the anode is free of the hexacyanoferrate complex.

25. The redox flow battery of claim 1, wherein the anode further comprises a negative electrolyte solution.

26. The redox flow battery of claim 1, wherein the cathode further comprises a positive electrolyte solution.

27. The redox flow battery of claim 1, wherein each of the anode, current collector, or cathode comprises the complex dispersed therein.

28. A solid charge storage material comprising anthraquinone 2-sulfonate, the complex having a structure according to Formula I of claim 1, or a mixture thereof.
